(19) United States
(12) Patent Application Publication
(10) Pub. No.: US 2024/0149510 A1
(43) Pub. Date: May 9, 2024

(54) MOLDING METHOD FOR PRODUCING A MOLDED PART

(71) Applicant: ENGEL AUSTRIA GmbH, Schwertberg (AT)

(72) Inventors: Guenther Klammer, Aschbach Markt (AT); Thomas Koepplmayr, Marchtrenk (AT)

(21) Appl. No.: 18/500,435

(22) Filed: Nov. 2, 2023

(30) Foreign Application Priority Data
Nov. 7, 2022 (AT) A 50843/2022

(51) Int. Cl. B29C 45/18; B29C 45/50; B29C 45/76

(52) U.S. Cl. CPC B29C 45/1866; B29C 45/50; B29C 45/7646; B29C 2945/7605; B29K 2105/0002

(57) ABSTRACT

A molding method produces a molded part from a polymer starting material in a molding machine, in particular an injection-molding machine. In the method, the polymer starting material is plasticized and/or fused, and at least one monomer in the gaseous state is supplied to the polymer starting material.

### BACKGROUND OF THE INVENTION

The present invention relates to a molding method, a molding machine, and a molded part.

The state of the art in the recycling of plastic waste comprises many different technologies. Particularly in the case of frequently used plastics such as polyethylene terephthalate (PET), recovery is becoming ever more important for ecological as well as economic reasons. So-called post-consumer PET or generally post-consumer waste (e.g. used beverage bottles) is collected, cleaned and processed into small pieces, usually regranulate or flakes. These can then be mixed together with new PET material in order to produce products from partially recycled PET (rPET).

PET is initially formed from monoethylene glycol (MEG) and terephthalic acid (TPA) by polycondensation or from dimethyl terephthalate by transesterification. That is to say, MEG and TPA are suitable monomers for the synthesis of PET and are thus basic constituents of PET. These two monomers react with each other in an equilibrium reaction to form PET, wherein the process control of this equilibrium reaction can be influenced by the addition or removal of products, reactants and/or intermediates as well as by process parameters such as temperature or pressure.

Used plastic articles such as PET bottles can be reprocessed by washing and comminuting these products. The regranulates or flakes forming therefrom can then be heated in so-called solid-state or liquid-state reactors with the exclusion of oxygen and water, for example in a vacuum, to <230° C. (solid state) or >270° C. (liquid state). Decomposed and shortened molecule chains of the polymer material, which can form due to aging processes during use, are joined to each other again and thus lengthened. Consequently, with the increasing crosslinking of the molecule chains, the viscosity of the polymer material also increases.

In contrast to applications in which an increased viscosity is desirable, polymers can be broken down again and/or their viscosity can be reduced. A method for this is the known glycolysis of PET (Lechleitner, A., Schwabl, D., Schubert, T, et al. Chemisches Recycling von gemischten Kunststoffällen als ergänzender Recyclingpfad zur Erhöhung der Recyclingquote [Chemical recycling of mixed plastic waste as a complementary recycling pathway for increasing the recycling rate]. Österr Wasser- und Abfallw 72, 47-60 (2020). https://doi.org/10.1007/s00506-109-00628-w Here, the PET material is broken down at temperatures of from 180° C. to 240° C. and by the addition of a glycol. In the process, the glycol diffuses into the structure of the polymer, which subsequently swells, and the glycol reacts with the ester bond. This mechanism is promoted by a large, specific surface area, for instance in the case of highly comminuted raw material such as regranulate or flakes.

In molding methods for producing thin-walled molded parts from rPET, a targeted viscosity reduction can be very important. A higher viscosity results in the need for higher injection pressures which are in turn only to be implemented with difficulty in mechanical engineering terms, in high temperature developments and consequently in material damage. It is therefore advantageous to lower the viscosity of waste bottles made of rPET with a typical, intrinsic viscosity (IV value) of from 0.7 dl/g to 0.8 dl/g, in order to be able to produce thin-walled injection products with wall thicknesses <1.5 mm.

During the production of transparent and thin-walled parts such as PET bottles, the material must be cooled sufficiently quickly after the injection, whereby crystalline areas are largely avoided, and the material remains in the amorphous state. Due to this quick cooling in conjunction with thin wall thicknesses, the material freezes quickly, and a complete filling of the molding tools is only possible in the case of a correspondingly low viscosity.

PET is also decomposed in an uncontrolled manner at temperatures >300° C. for sufficient time. This decomposition is further intensified in the presence of water and/or oxygen. This results in an increasing content of acetaldehyde as cleavage product and thus in poorer mechanical properties and/or in an undesired yellowing.

It is thus advantageous to lower the IV value of the polymer material to from 0.5 dl/g to 0.6 dl/g, in order to keep the injection pressure <2400 bar and the temperature <300° C. and to produce completely molded quality products.

In order to bring about a viscosity reduction, a monomer such as MEG is for example added to an rPET starting material in a pressure-free region, preferably in a material hopper by premixing or following a degassing zone in an extruder. It has already been demonstrated that the addition of from 2 wt.-% to 3 wt.-% glycol results in a significant reduction in the viscosity. If MEG is added in the flowable state (>270° C.) instead of by premixing to an rPET melt, in the case of coordinated concentration ratios it can result in a better viscosity reduction in the manner of a glycolysis of PET. An article on this has recently been published in the journal “Kunststoffe [Plastics]” (Keilbach, F.-X., Prizinitzki D. Mit Glykol wird der Extruder zum Turbo [Glycol turns the extruder into a turbo]. Kunststoffe, Carl Hanser Verlag Munich, 1 (2022). https://www.kunstsoffe.de/a/fachartikel/mit-glykol-wird-der-extruder-zum-turbo-358226. However, it is apparent in the case of glycol quantities >5% that steam generation and consequently the risk of ignition (flash point 111° C., ignition temperature 410° C.) can occur. The boiling point of ethylene glycol is 197° C., the processing temperature of PET is usually in the range 270° C. to 290° C.

In addition to the risk potential, a further disadvantage results due to the insufficient homogenization, i.e., the uniform mixing-in and distribution, of the monomer in the polymer starting material.

The distribution of the monomer needs to be improved in order to achieve a more uniform and better-controlled viscosity reduction in the material.

### SUMMARY OF THE INVENTION

The object of the present invention is therefore to provide a method which improves the above-named state of the art with respect to the disadvantages thereof. Thus, a method is to be provided which effects a better distribution of the desired viscosity reduction of a polymer starting material.

This is achieved through the provision of a molding method for producing a molded part from a polymer starting material in a molding machine, in particular an injection-molding machine, wherein the polymer starting material is plasticized and/or fused and at least one monomer in the gaseous state is supplied to the polymer starting material.

A fundamental aspect of the invention is that at least one monomer, which is suitable for the synthesis of a polymer starting material and/or is a basic constituent of a polymer starting material, is supplied to the polymer starting material in the gaseous state.

The gaseous supplying of the monomer results in a better and more uniform distribution and mixing-in of the monomer within the polymer starting material. Thereafter, it results in a more homogeneous viscosity reduction within the polymer starting material and, associated with this, in an increase in quality of the polymer starting material and of a molded part produced therewith.

In this way, for example, thin-walled injection products made of rPET can be produced more easily, more efficiently, with the aid of lower injection pressures or spraying pressures, in better quality, with fewer rejects, in a shorter time and/or more cost-effectively.

Preferably, the at least one monomer is heated in a sealed container, in particular protected from oxygen, and supplied to the plasticized and/or fused polymer starting material, in particular is injected into the plasticized and/or fused polymer starting material. Leaks and the formation of an inflammable air-gas mixture can thus be largely avoided.

Also, more than one type of polymer starting material can be used. For example, when the polymer starting material PET is used, a second polymer starting material such as for example polyethylene naphthalate (PEN) can additionally also be used. Thus, two or more polymer starting materials can be used. In terms of procedure, it is advantageous if a monomer which is suitable for the synthesis of the polymer starting materials used is supplied, or if only one such monomer has to be supplied.

In particular, in the case of the two polymer starting materials PET and/or PEN, but also in the case of other polymer starting materials, MEG can be an appropriate monomer for more than one polymer starting material.

In a previous step, the monomer can first be heated to a particular temperature, preferably >200° C., and/or compressed with a particular pressure before it is supplied to the polymer starting material in the gaseous state.

A polymer is a substance consisting of macromolecules. Synthetic polymers are substances which are formed by polyreactions, i.e. in other words by polymerization reactions such as chain polymerization, polyaddition or polycondensation.

A monomer is a small, reactive molecule, which is suitable as a basic building block for macromolecules and/or polymers.

The phrase “at least one monomer in the gaseous state is supplied to the polymer starting material” can be expressed in other words as follows:

The at least one monomer is in the gaseous state when the boiling point of the at least one monomer is reached and/or exceeded. That is to say the solid-gas phase boundary line or the liquid-gas phase boundary line of the at least one monomer is crossed. That is to say the at least one monomer is present as a gas.

“Supply” in this context means that the at least one monomer is brought into contact with the polymer starting material. In a molding machine, therefore, it makes sense in a preferred embodiment that the at least one monomer is introduced into a mass cylinder in which the polymer starting material is located. “Supplying the at least one monomer in the gaseous state” in this embodiment can mean that the at least one monomer is injected into the mass cylinder as a gas and consequently is brought into contact with the plasticized and/or fused polymer starting material. This contact can be increased through the rotational movement of a screw, which mixes, preferably homogenizes, the mixture of substances consisting of gaseous monomer and plasticized and/or fused polymer starting material.

At this point, it will also be explicitly pointed out that the phrase “at least one monomer in the gaseous state is supplied to the polymer starting material” means that the at least one monomer is substantially in the gaseous state at the moment it is supplied to the polymer starting material, specifically when it is introduced into a mass cylinder of a plasticizing unit or of an injection unit and/or when it is first brought into contact and/or when it first comes into contact with the polymer starting material. In addition, it is conceivable that the at least one monomer at least partially or completely adopts a different aggregate state before or after being supplied.

A plasticizing unit is a device with a screw for plasticizing and/or fusing polymer starting material. Such a plasticizing unit can receive the polymer starting material, usually in the form of granules, via an inlet opening and carry the polymer starting material, usually in the form of a plasticized and/or fused material, forward via an outlet opening. In a simple embodiment the plasticizing unit is a screw extruder. However, there is also the possibility that the plasticizing unit undertakes further functions, such as for example the injection of the polymer starting material. In this case, the plasticizing unit is simultaneously also an injection unit.

The screw can be a plasticizing screw and/or a reciprocating screw. Plasticizing screws are mounted and driven rotatable in the mass cylinder. For example, in an extruder, plasticizing screws which are built in the mass cylinder in an axially fixed manner are used.

Reciprocating screws are arranged and driven not only rotatable but also axially displaceable in the mass cylinder. Injection processes can thus also be carried out with reciprocating screws.

An injection unit is a plasticizing unit which is capable of injecting polymer starting material, preferably with a particular pressure, into a molding tool.

The screw of a plasticizing unit can have different zones, which are explained hereinafter.

A feed zone is that region of a screw of a plasticizing unit in which the polymer starting material is received by the screw and the plasticizing and/or fusing of this polymer starting material is possibly already started.

A compression zone is that region of a screw of a plasticizing unit in which the polymer starting material is plasticized and/or fused as well as compressed. The degree of filling in the screw channel consequently increases. The pressure of the plasticized and/or fused polymer starting material usually increases continuously in the compression zone. There can be more than one compression zone along a screw.

A decompression zone is that region of a screw of a plasticizing unit in which the pressure of the plasticized and/or fused polymer starting material is lower than in another region of the screw. There can be more than one decompression zone along a screw.

Compared with compression zones, decompression zones preferably have a greater channel depth and/or a greater pitch of at least one screw channel—preferably of all screw channels—of the screw.

A mixing zone is that region of a screw of a plasticizing unit in which special mixing elements are provided on the screw, as a result of which the mixing performance increases. This is particularly important in the case of homogeneous mixing-in of additives, such as for example in the case of a monomer. There can be more than one mixing zone along a screw.

A degassing zone is that region of a screw of a plasticizing unit in which the degree of filling in the screw channel is less than 100% and volatile constituents of the melt can thus escape in the form of gas. The escape is usually effected via a degassing socket. There can be more than one degassing zone along a screw.

A metering zone is that region of a screw of a plasticizing unit in which the plasticized and/or fused polymer starting material is homogenized, compressed and then carried forward through an outlet opening. In the case of an injection unit, the plasticized and/or fused polymer starting material can be compressed even further by an axially movable screw and then injected with a particular injection pressure through an injection nozzle into a molding tool.

A low-pressure region is a region in a plasticizing unit and/or an injection unit in which a lower pressure than in another region of the plasticizing unit and/or of the injection unit prevails. Such a low-pressure region can preferably have a pressure of less than 5 bar. Such a region can be formed in that the channel volume in a plasticizing unit and/or an injection unit is larger than the conveyed volume of a plasticized and/or fused polymer starting material. Such a low-pressure region preferably extends over a length of once to twice the length of the screw diameter in this region. There can be more than one low-pressure region along a screw.

It is to be noted that a low-pressure region can simultaneously be a decompression zone, a degassing zone and/or a feed zone.

A device according to the invention can be used and subsequently installed in known embodiments of the state of the art which are disclosed in this description.

In a preferred embodiment, the polymer starting material is transferred from a plasticizing unit to an injection unit.

The polymer starting material can be transferred from a plasticizing unit to an injection unit before, during and/or after the supplying of the monomer.

In a preferred embodiment, the monomer is supplied to the polymer starting material in a low-pressure region, preferably in a decompression zone, in a degassing zone and/or in a feed zone, of the plasticizing unit and/or of the injection unit, preferably wherein a low-pressure region represents a region with a pressure of less than 5 bar.

In a preferred embodiment, the low-pressure region, preferably the decompression zone, the degassing zone and/or the feed zone, of the plasticizing unit and/or of the injection unit has a region of low pressure, preferably over a length of from one up to two screw diameters, in which a degassing of the polymer starting material is brought about and/or the monomer is supplied due to atmospheric pressure or negative pressure.

In a preferred embodiment, the monomer is supplied in a mixing zone of the plasticizing unit and/or of the injection unit.

In a preferred embodiment, the plasticizing unit and/or the injection unit is equipped with a reciprocating screw, which is preferably partially filled in a low-pressure region, preferably in a decompression zone, in a degassing zone and/or in a feed zone.

In a preferred embodiment, the polymer starting material is filtered with a filter before, during and/or after the supplying of the monomer.

In a preferred embodiment, the viscosity of the polymer starting material is measured with at least one rheometer on the molding machine, in particular on the injection-molding machine, before, during and/or after the supplying of the monomer. The at least one rheometer is arranged after the plasticizing unit, preferably between the plasticizing unit and the clamping unit and/or between the plasticizing unit and the injection unit and/or between the injection unit and the clamping unit.

Particularly preferably, through the measured values of the rheometer or another measuring instrument, the supplying of the monomer is controlled and/or regulated. Thus, for example, in the case of too low a viscosity, measured after the supplying of the monomer, a smaller quantity of supplied monomer can be set, and vice versa. On the other hand, it is likewise conceivable, with the aid of a viscosity measured before the supplying of the monomer and/or a correlating variable, to control and/or regulate the supply parameters of the monomer.

All measured variables before, during and/or after the supplying of the monomer can be used for process monitoring, process control and/or process regulation. In a preferred embodiment, an adaptation of the quantity, temperature and/or pressure of the monomer supplied to the polymer starting material and/or of the polymer starting material can be monitored, controlled and/or regulated during operation.

In a preferred embodiment, the polymer starting material after the supplying of the monomer has an intrinsic viscosity of at most 0.8 dl/g, in particular 0.4 dl/g to 0.7 dl/g, in particular 0.5 dl/g to 0.6 dl/g.

The intrinsic viscosity can, for example, be measured according to standard DIN EN ISO 1628-5:2015-05.

In a preferred embodiment, the supplied quantity of the polymer starting material and/or of the monomer is measured, controlled and/or regulated.

In a preferred embodiment, the polymer starting material is a polycondensate, in particular a polyester, in particular polyethylene terephthalate (PET), polytrimethylene terephthalate (PTT), polybutylene terephthalate (PBT), polylactide (PLA), polyhydroxybutyrate (PHB), polyethylene naphthalate (PEN), polycarbonate (PC), polyester carbonate (PEC) and/or polyarylate (PAR).

In a further embodiment, the polymer starting material is a copolymer, in particular a copolycondensate, preferably a copolyester. A copolymer is a polymer which is synthesized from two or more different monomers. Analogously, a copolyester is a polyester which, in addition to the two monomers necessary for the synthesis of this polyester, contains at least one other monomer. For example, a copolyester can be a modified PET in which, in addition to the monomers necessary for the PET synthesis, terephthalic acid and ethylene glycol, further monomers such as isophthalic acid and/or 1,4-cyclohexanedimethanol are also incorporated.

In a preferred embodiment, the monomer is suitable for the synthesis of the polymer starting material and has at least one hydroxyl group, carboxyl group, organyloxycarbonyl group and/or a halocarbonyl group, preferably is a diol or a hydroxycarboxylic acid or a dicarboxylic acid, in particular ethylene glycol (1,2-ethanediol), 1,3-propanediol, 1,4-butanediol, 2-hydroxypropanoic acid and/or 3-hydroxybutanoic acid.

If a monomer that is suitable for the synthesis of the polymer starting material is used without further constituents, i.e., without further foreign constituents, the polymer chains of the polymer starting material are shortened and thus the viscosity thereof is reduced. If, in addition to the monomer, further constituents are added, other chemical reactions and/or material changes can also be brought about in addition to a shortening of the polymer chains. The modification of a polymer starting material is in no way limited only to bringing about a viscosity reduction through the supplying of a monomer. Any material modification which is conceivable alongside the molding method according to the invention can be implemented in addition and as a supplement.

In a preferred embodiment, a gas mixture consisting of monomer and inert gas as entrainer, preferably nitrogen and/or carbon dioxide, is supplied.

In such an embodiment, through a gas mixture consisting of a monomer and a propellant gas such as nitrogen, a molding machine and a molding method can be provided, in which the viscosity of the polymer starting material is altered in a targeted manner and at the same time a foaming is brought about.

In a preferred embodiment, a mixture consisting of monomer and a nucleating agent, preferably mineral fillers and/or polymer materials that differ from the polymer starting material, is supplied as a gas mixture and/or as an aerosol.

Some packaging from the food sector is either filled at up to 100° C. or heat-sterilized, i.e. briefly heated up to 120° C. PET has a glass transition temperature of 70° C. and does not withstand this thermal loading in the amorphous state. Such products according to the state of the art are therefore nucleated, whereby crystalline regions form which do not melt until 250° C. to 260° C. An uncontrolled crystallization readily results in the embrittlement of the products, which is why a slower cooling in the injection-molding tool does not have the desired effect. Mineral fillers such as chalk or foreign plastics such as polyethylene (PE) are for example used in small quantities as nucleating agent. There are also specially adjusted masterbatches for achieving the greatest possible number of nucleation sites and finely dispersed spherulites.

Protection is furthermore sought for a molding machine, in particular an injection-molding machine, in particular set up for carrying out a molding method according to the invention, for producing a molded part from a polymer starting material with a plasticizing unit and/or an injection unit for plasticizing, for fusing and/or for injecting the polymer starting material and with a supply device for supplying at least one monomer in the gaseous state to the polymer starting material.

Protection is furthermore sought for a molded part, in particular injection-molded product, which is produced according to a molding method according to the invention.

In a preferred embodiment, the molded part, in particular injection-molded product, is a polymer product and the polymer product is thin-walled, preferably has a wall thickness of less than 1.5 mm, preferably less than 1 mm.

By molding machines may be meant injection-molding machines, transfer-molding machines, presses and the like. Molding machines in which the plasticized material is supplied to an open mold are also entirely conceivable.

### BRIEF DESCRIPTION OF THE DRAWINGS

Further advantages and details of preferred embodiments of the invention are revealed with reference to the figures and the associated descriptions of the figures, in which:

FIG. 1 shows an embodiment of a method according to the invention in a one-stage process;

FIG. 2 shows an embodiment of a method according to the invention in a two-stage process with supply of the gaseous monomer into the first plasticizing unit; and

FIG. 3 shows an embodiment of a method according to the invention in a two-stage process with supply of the gaseous monomer into the second plasticizing unit.

### DETAILED DESCRIPTION OF THE INVENTION

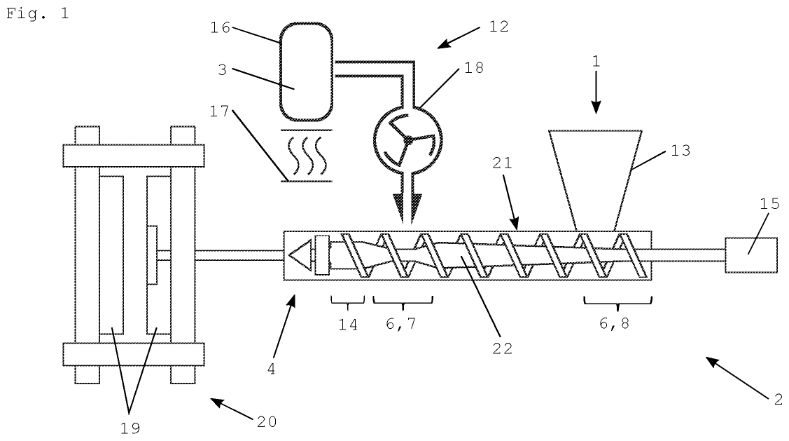

FIG. 1 shows a molding machine 2 with indicated clamping unit 20 and a plasticizing unit 4. In this embodiment, the molding tool 19 is in two parts and is shown in the state installed on the clamping unit 20.

In this embodiment, the method is effected in a one-stage process. That is to say the supply of a monomer 3 and the plasticizing and/or the fusing of a polymer starting material 1 take place in one plasticizing unit 4.

The plasticizing unit 4 has a mass cylinder 21.

The plasticizing unit 4 is connected, on one side, via a line to one of the two molding tools 19 and, on the other side, to a drive 15 which drives the plasticizing screw 22 in the plasticizing unit 4. The polymer starting material 1 can be supplied to the plasticizing screw 22 via a material hopper 13, which is arranged on the plasticizing unit 4 on the drive side.

Once the polymer starting material 1 from the material hopper 13, which is usually present there as granules in the form of flakes, pellets or the like, has been fed into the feed zone 8, the polymer starting material 1 is transported further via the rotating plasticizing screw 22. As is usual in plasticizing units 4, the plasticizing screw 22 consists of various zones.

Low-pressure regions 6 in this embodiment are the degassing zone 7 and the feed zone 8. The feed zone 8 is that region of the plasticizing screw 22 in which the polymer starting material 1 is supplied via the material hopper 13. In the feed zone 8, the screw root diameter is usually constant. In this embodiment the feed zone 8 is followed by a compression zone, in which the screw root diameter increases steadily and thus the polymer starting material 1 is plasticized or fused using suitable pressure (compression) and temperature conditions. This zone is therefore called the compression zone. The degassing zone 7 has a smaller screw root diameter than the largest screw root diameter of the compression zone, therefore the degassing zone 7 is a low-pressure region 6, which is also called the decompression zone. In this embodiment this is followed, as the final zone, by the metering zone 14, in which the desired quantity of sufficiently plasticized or fused and homogenized polymer starting material 1 is present and is passed, preferably injected, into the molding tool 19 via a line.

In this embodiment the supply of at least one monomer 3 is effected via a supply device 12 into a low-pressure region 6, specifically into the degassing zone 7. The supply device 12 has a container 16, in which the gaseous or at least partially gaseous monomer 3 is located, and a heating element 17 heating the container 16. Using a compressor 18, the gaseous and preheated monomer 3 can be passed into the degassing zone 7 via a line.

Through the compressor 18, the gas pressure is high enough to supply the gaseous monomer 3 to the polymer starting material 1 in the degassing zone 7. That is to say, in other words, the gas pressure exceeds the pressure of the plasticized and/or fused polymer starting material 1 at the point the monomer 3 is supplied. In preferred embodiment variants it can be provided to measure the pressure and/or the temperature of the gaseous monomer 3 and/or of the plasticized and/or fused polymer starting material 1, for example with the aid of a sensor. For this, in a preferred embodiment at least one pressure transducer and/or at least one temperature sensor and/or at least one other suitable measuring instrument can be used in a mass cylinder and/or in a compressor.

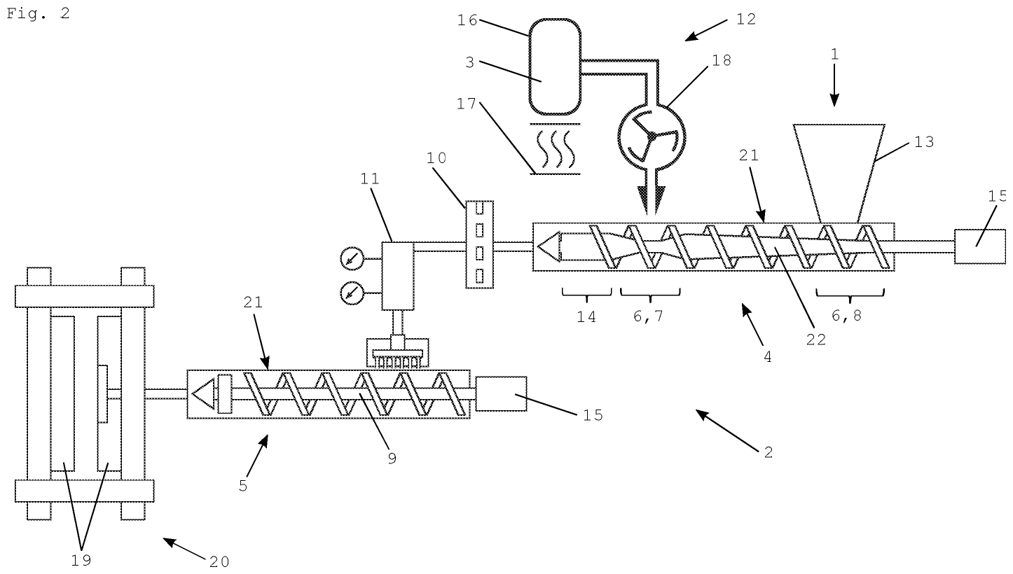

FIG. 2 shows a molding machine 2 with an indicated clamping unit 20, a plasticizing unit 4 and an injection unit 5. In this embodiment the molding tool 19 is in two parts and is shown in the state installed on the clamping unit 20.

In this embodiment the plasticizing unit 4 and the supply of a polymer starting material 1 and of a monomer 3 correspond to the embodiment in FIG. 1.

Additionally with respect to the embodiment in FIG. 1, a filter 10, a rheometer 11 and an injection unit 5 are also provided here between the plasticizing unit 4 and the clamping unit 20 including molding tools 19.

In this embodiment, the method is effected in a two-stage process. That is to say the supply of a monomer 3 and the plasticizing or the fusing of a polymer starting material 1 take place in the plasticizing unit 4. In this embodiment, after a filter 10 and a rheometer 11, a second stage with an injection unit 5 is provided, in which the polymer starting material 1 with the supplied monomer 3 is further homogenized and degassed. This means that, in the course of the second stage, volatile substances such as unreacted MEG and/or contaminants can be removed.

The filter 10 can be a melt filter customary in the trade. Through the plasticizing screw 22 of the plasticizing unit 4 driven by the first drive 15, the polymer starting material 1 can be pressed through the filter 10 in order thus to remove contaminants.

The viscosity of the polymer starting material 1 can be reduced by the supplied monomer 3. If the supplying of the monomer 3 takes place before the filter 10, as in this embodiment, finer filters can be used in order to remove small contaminants from the plasticized or fused polymer starting material 1 with the supplied monomer 3.

The lower the viscosity of the polymer starting material 1 is, the finer the filters that can be used and the smaller the contaminants that can be removed from the polymer starting material 1.

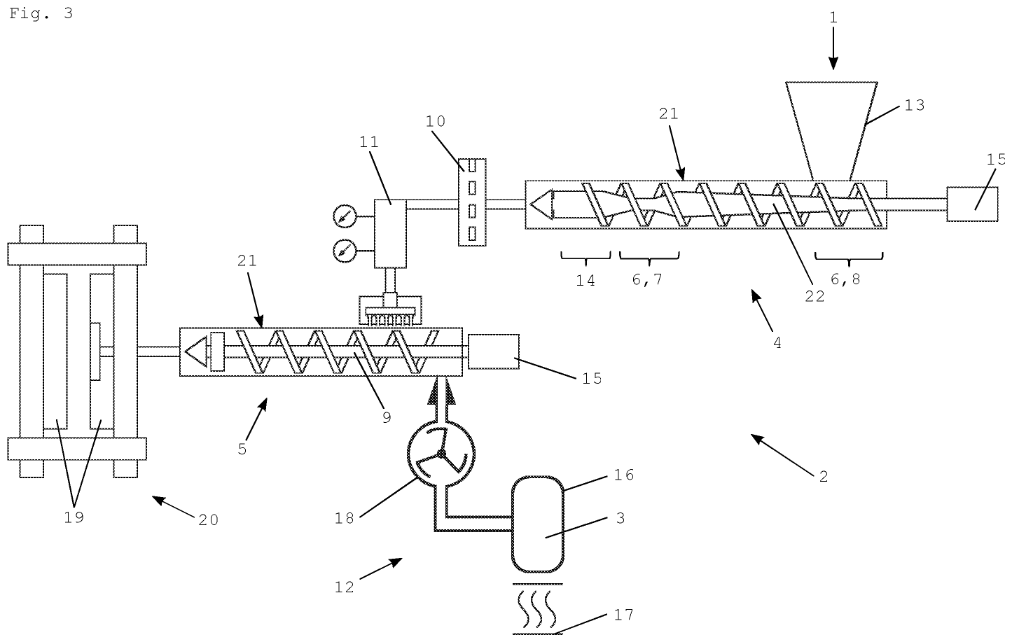

It is conceivable, as shown in another embodiment in FIG. 3, that the supplying of the monomer 3 can take place after the filter 10. However, it is also conceivable that the supplying of the monomer 3 is provided at any one or more desired points within the molding machine 2, in particular the injection-molding machine.

A filtering can be effected before, after and/or during the supply of the monomer 3.

A rheometer 11, which measures the viscosity of the polymer starting material 1, is arranged after the filter 10.

In this embodiment an inline measurement is provided, in which the rheometer 11 is arranged directly and immediately in the process line conducting the polymer starting material 1. In this way, measurements that are continuous, precise and carried out in real time are possible.

An inline measurement can be effected before, after and/or during the supply of the monomer 3.

The measurement of the viscosity can be effected online in another embodiment. For example, a branch or a bypass from the process line conducting the polymer starting material 1 is provided, in which the rheometer 11 is arranged. The measurement then no longer takes place directly and immediately in the process line. In the case of an online measurement, continuous measurements can be carried out.

An online measurement can be effected before and/or after the supply of the monomer 3.

Instead of or in addition to inline and/or online measurements of the viscosity of the polymer starting material 1, it can be provided that samples of the polymer starting material 1 are taken from the molding machine 2 and are examined on site and/or at another site.

Through a measurement of the viscosity of the polymer starting material 1, decisions can be made during the molding method. For example, through a measurement of the viscosity of the polymer starting material 1 which is carried out inline or online, the quantity of monomer 3 added or polymer starting material 1 fed in during operation of the molding machine 2 can be adapted. On the basis of the measured data which are obtained by the filter 10 and/or the rheometer 11, other method parameters can also be adapted, such as for example extrusion rate, temperature, temperature progression, metering volume, pressure, pressure progression, emergency stop etc.

Adaptations of the method parameters can be carried out using measurement results of the filter 10 and/or of the rheometer 11 both manually by operating personnel and in an automated manner by corresponding programs as well as control and regulating circuits. In this connection, communication in a network, for example a machine park with several machines, is also possible.

In this embodiment in FIG. 2, after the rheometer 11 an injection unit 5 is provided, which contains a reciprocating screw 9 driven by a second drive 15.

By reciprocating screws is meant screws which are mounted both rotatable and axially displaceable in a mass cylinder.

The reciprocating screw 9 of the injection unit 5 can have a constant screw diameter. In another embodiment it is possible for the channel depth and/or the pitch of at least one of the screw channels of the reciprocating screw to vary in order to provide compression zones and decompression zones. In addition to gassing and degassing, the injection unit 5 can bring about a higher quality of the polymer starting material 1 through further homogenization.

Preferably, the feed zone 8 of the reciprocating screw 9 of the injection unit 5 is partially filled and thus represents a low-pressure region 6.

Preferably, the feed zone 8 of the reciprocating screw 9 of the injection unit 5 is partially filled and thus represents a low-pressure region 6, in which the monomer 3 in the gaseous state can be supplied. Such an embodiment is represented in FIG. 3.

Preferably, the feed zone 8 of the reciprocating screw 9 of the injection unit 5 is partially filled and makes a degassing of the polymer starting material 1 possible due to atmospheric pressure or negative pressure.

Preferably, the feed zone 8 of the reciprocating screw 9 of the injection unit 5 is partially filled and thus represents a low-pressure region 6, which reaches over a length of from 1 to 2 screw diameters.

FIG. 3 shows a molding machine 2 with an indicated clamping unit 20, a plasticizing unit 4 and an injection unit 5. In this embodiment the molding tool 19 is in two parts and is shown in the state installed on the clamping unit 20.

In this embodiment, the plasticizing unit 4 and the injection unit 5 as well as the indicated clamping unit 20 correspond to the embodiment in FIG. 2.

In this embodiment, the method is effected in a two-stage process, as in FIG. 2. In this embodiment, the polymer starting material 1 is plasticized by the plasticizing unit 4 in a first step. After that, the polymer starting material 1 is passed through the filter 10 and the rheometer 11 and supplied to the injection unit 5. In the second stage, the monomer 3 is supplied to the polymer starting material 1 in the injection unit 5 and homogenized by the reciprocating screw 9 in order subsequently to be passed into the molding tool 19 by the injection unit 5. The way in which the monomer 3 is supplied corresponds to the embodiment from FIG. 2.

In contrast to the embodiment in FIG. 2, the supplying of the monomer 3 is only provided in the injection unit 5 here.

With respect to the injection unit 5, in another embodiment it can be provided that the feed zone is simultaneously a degassing zone.

### LIST OF REFERENCE NUMBERS

1 polymer starting material
2 molding machine
3 monomer
4 plasticizing unit
5 injection unit
6 low-pressure region
7 degassing zone
8 feed zone
9 reciprocating screw
10 filter
11 rheometer
12 supply device
13 material hopper
14 metering zone
15 drive
16 container
17 heating element
18 compressor
19 molding tool
20 clamping unit
21 mass cylinder
22 plasticizing screw

1. A molding method for producing a molded part from a polymer starting material in a molding machine, in particular an injection-molding machine, comprises plasticizing and/or fusing the polymer starting material, and supplying at least one monomer in the gaseous state to the polymer starting material.

2. The molding method according to claim 1, wherein the polymer starting material is transferred from a plasticizing unit to an injection unit.

3. The molding method according to claim 1, wherein the monomer is supplied to the polymer starting material in a low-pressure region, preferably in a decompression zone, in a degassing zone and/or in a feed zone, of the plasticizing unit and/or of the injection unit, preferably wherein a low-pressure region represents a region with a pressure of less than 5 bar.

4. The molding method according to claim 1, wherein the low-pressure region, preferably the decompression zone, the degassing zone and/or the feed zone, of the plasticizing unit and/or of the injection unit has a region of low pressure, preferably over a length of from one up to two screw diameters, in which a degassing of the polymer starting material is brought about and/or the monomer is supplied due to atmospheric pressure or negative pressure.

5. The molding method according to claim 1, wherein the monomer is supplied in a mixing zone of the plasticizing unit and/or of the injection unit.

6. The molding method according to claim 1, wherein the plasticizing unit and/or the injection unit is equipped with a reciprocating screw, which is preferably partially filled in a low-pressure region, preferably in a decompression zone, in a degassing zone and/or in a feed zone.

7. The molding method according to claim 1, wherein the polymer starting material is filtered with a filter before, during and/or after the supplying of the monomer.

8. The molding method according to claim 1, wherein the viscosity of the polymer starting material is measured with at least one rheometer on the molding machine, in particular on the injection-molding machine, before, during and/or after the supplying of the monomer, wherein the at least one rheometer is arranged after the plasticizing unit, preferably between the plasticizing unit and the clamping unit and/or between the plasticizing unit and the injection unit and/or between the injection unit and the clamping unit.

9. The molding method according to claim 1, wherein the polymer starting material after the supplying of the monomer has an intrinsic viscosity of at most 0.8 dl/g, in particular 0.4 dl/g to 0.7 dl/g, in particular 0.5 dl/g to 0.6 dl/g.

10. The molding method according to claim 1, wherein the supplied quantity of the polymer starting material and/or of the monomer is measured, controlled and/or regulated.

11. The molding method according to claim 1, wherein the polymer starting material is a polycondensate, in particular a polyester, in particular polyethylene terephthalate (PET), polytrimethylene terephthalate (PTT), polybutylene terephthalate (PBT), polylactide (PLA), polyhydroxybutyrate (PHB), polyethylene naphthalate (PEN), polycarbonate (PC), polyester carbonate (PEC) and/or polyarylate (PAR).

12. The molding method according to claim 1, wherein the monomer is suitable for the synthesis of the polymer starting material and/or has at least one hydroxyl group, carboxyl group, organyloxycarbonyl group and/or a halocarbonyl group, preferably is a diol and/or a hydroxycarboxylic acid and/or a dicarboxylic acid, in particular ethylene glycol (1,2-ethanediol), 1,3-propanediol, 1,4-butanediol, 2-hydroxypropanoic acid and/or 3-hydroxybutanoic acid.

13. The molding method according to claim 1, wherein a gas mixture consisting of monomer and inert gas as entrainer, preferably nitrogen and/or carbon dioxide, is supplied.

14. The molding method according to claim 1, wherein a mixture consisting of monomer and a nucleating agent, preferably mineral fillers and/or polymer materials that differ from the polymer starting material, is supplied as a gas mixture and/or as an aerosol.

15. A molding machine, in particular an injection-molding machine, in particular set up for carrying out the molding method according to claim 1, for producing a molded part from a polymer starting material with a plasticizing unit and/or an injection unit for plasticizing, for fusing and/or for injecting the polymer starting material and with a supply device for supplying at least one monomer in the gaseous state to the polymer starting material.

16. A molded part, in particular injection-molded product, which is produced according to the molding method of claim 1.

17. The molded part, in particular injection-molded product, according to claim 16, wherein the molded part is a polymer product and the polymer product is thin-walled, preferably has a wall thickness of less than 1.5 mm, preferably less than 1 mm.
